(19) United States
(12) Patent Application Publication
(10) Pub. No.: US 2026/0296394 A1
(43) Pub. Date: Oct. 1, 2026

(54) ARRANGEMENT FOR A LINEAR MAGNET FOR ELECTRONICALLY ASSISTED BRAKING SYSTEMS

(71) Applicant: Brembo S.p.A., Curno, Bergamo (IT)

(72) Inventor: Martina TRUFFELLO, Curno, Bergamo (IT)

(21) Appl. No.: 19/489,426

(22) PCT Filed: May 31, 2024
(86) PCT No.: PCT/IB2024/055329

§ 371 Date: Dec. 2, 2025

(30) Foreign Application Priority Data
Jun. 5, 2023 (IT) 102023000011307

(51) Int. Cl. B60T 17/22; B60T 7/04; B60T 8/40; G01D 5/14; G01D 5/16

(52) U.S. Cl. CPC B60T 17/22; B60T 7/042; B60T 8/4081; G01D 5/145; G01D 5/16; B60T 2220/04

(57) ABSTRACT

Arrangement for a linear magnet for electronically assisted braking systems The present invention relates to a magnet housing device (140) for a linear position sensor installed on a sliding element in a longitudinal direction (Y), comprising: —a magnet housing body (145) with a first surface extending along said longitudinal direction (Y) and a second surface extending along said longitudinal direction (Y) opposite to the first surface; —a threaded bushing (143) projecting from said second surface; wherein the threaded bushing (143) has an outer bushing surface with a poka-yoke element (142), as well as a cylindrical opening (144a) in a direction perpendicular to said longitudinal direction (Y), said cylindrical opening (144a) having an inner thread. The present invention further relates to a foot brake which uses the magnet housing device (140) according to the invention.

### BACKGROUND ART

The present invention relates to an arrangement for a linear magnet for electronically assisted braking systems.

Braking power boosters are used to reduce the actuation force of a brake of a vehicle, in particular a motorcar, in order to achieve a desired braking effect for the user. For such a purpose, vacuum brake boosters are usually installed on vehicles. Meanwhile, however, electric brake boosters have also been increasingly used in the corresponding braking systems. While in the case of vacuum brake boosters, the actuation of a brake pedal as a signal transmitter is transmitted mechanically to the brake booster, this is no longer the case with electric brake boosters (Brake-By-Wire (“BBW”)). Therefore, sensor devices intended to detect the position or movement Of the signal transmitter, in particular of the contactless type, are provided. Usually, one or more linearly movable permanent magnets, the magnetic field of which is detected by a fixed sensor, are used for such a purpose.

The use of linear stroke magnets (hereafter “linear magnets” for brevity) in braking systems, which use position sensors, is thus known. Sometimes, such magnets have a linear extension themselves.

Linear magnets for position sensors are generally critical because of the axial dimensions of their stroke.

For example, in a product from the Sensify line of the Applicant (see FIG. 1), a magnet MG (MG indicates the area of the casing in which the magnet extends) with linear extension requires a total axial space of 37 mm along the direction AS. A length of 14 mm is related to the fixing zone in which a bushing BC (first constraint) is molded to ensure vibration resistance and durability of the magnet. A plastic pin GF (second constraint) is molded under the magnet itself to ensure the correct constraining of the component and tightening of the bolts. By virtue of the pin, the magnet is rotationally locked and vibrations are damped in cooperation with the constraint of the bushing, and the bending of the magnet as well as the risk of splitting the product are also avoided. The pin must be accommodated by another brake component, the so-called “float”.

The magnet casing CM and the fixing geometry GF have a direct impact on piston cost and geometry. Moreover, it is necessary to ensure the orientation of the magnet installation to provide the correct magnetic field for the sensor. For this reason, a poka-yoke function was designed directly on the float. A design of this type has two main limitations: it requires significant axial space and increases the complexity of the piston and magnet design and thus the cost. Moreover, this design is not suitable for motorcycle applications in which the dimensions are the main constraint to ensure that an electro-actuated pedal adequately replaces rear pedal pumps in mass production. Nor can the dimensions of the magnet be reduced because the position sensor using it would not provide the necessary measurement accuracy.

Other solutions on the market involve the integration of the sensor into the piston:
Mando has developed a design (U.S. Pat. No. 9,383,279 B2) in which the magnet is coupled to the piston by means of a plastic ring. This type of design avoids the magnet from coming into contact with the brake fluid but increases the radial diameter; this is not suitable for brakes having a rigid volume constraint; and
Bosch has developed a different device (DE102013214969 A1), in which the magnet has a too large axial stroke, is not in contact with brake fluid, and there is no integration of poka-yoke functionality.

In greater detail, document U.S. Pat. No. 9,383,279 B2 to Mando describes an installation structure of a stroke sensor of a brake pedal configured to measure the displacement of a movable element, which interacts according to a pressure force of a brake pedal. The pedal stroke sensor is provided with a detection element to detect in a contactless manner a change in displacement based on the movement of the movable part and is installed outside a housing, which allows the movable part to slide therein, the detection element being provided with a sensor housing which is removably installed outside the housing, a Hall-effect integrated circuit provided in the sensor housing to detect the change in magnetic force, and a magnet housing provided in the sensor housing so as to move when facing the Hall-effect integrated circuit and on which a magnet is installed, as well as an elongated hole is formed through the outer surface of the housing in a direction in which the movable element moves, and the movable element is connected to the magnet housing using a connection element so that the movable element moves together with the magnet housing through the elongated hole. FIG. 2 shows FIG. 5 of the patent, in which the axial stroke of the magnet 140 is clearly visible.

Document DE102013214969 A1 to Bosch describes a retaining device for at least one permanent magnet, in particular a sensor device, comprising a retaining element which has at least one accommodation pocket to receive the at least one permanent magnet. According to the document, there is at least one leaf spring which is arranged on the retaining element so as to push the at least one permanent magnet into the accommodation pocket with a pretensioning force. FIG. 3 shows FIG. 3 of the patent, in which the axial extension of the magnet 3, 4 is clearly visible.

Document EP 3 355 031 A1 describes a displacement-detecting apparatus mounted in a linear motion mechanism having a nut element and a rod coupled as a screw to the nut element to convert the rotary motion of the nut element into a rectilinear motion of the rod to detect an axial displacement of the rod using a displacement sensor. The displacement detecting apparatus comprises: a permanent magnet arranged parallel to the rod and facing the displacement sensor; a magnetic block having a retaining portion which accommodates the permanent magnet, and a support portion formed continuously and integrally with the retaining portion and fixed to the rod; a casing having vertical wall portions parallel to an axis of the rod and housing the magnetic block between the pair of vertical wall portions; and biasing mechanisms interposed between the upright wall portions and the support portion, respectively. This solution is based on a screw coupling of the magnet, which under the high stresses of use results in the possibility of rotation of the magnet casing, no poka-yoke functionality being provided, the fixing screw being a fixing means subject to loosening and not a poka-yoke element. Moreover, the nut is provided in series with the linear magnet, increasing the axial size thereof.

Current designs of a linear magnet have the following problems:
the axial size of the magnet is considerably large due to the design of the fixing with positioning in series with the linear magnet;
the poka-yoke functionality (error-proof design) is ensured by the plastic casing for the fixing design, which cannot be removed;
a plastic pin is introduced under the magnet to have an isostatic system and thus pass the vibration resistance test; and
the complexity and cost of piston design are related to the points listed above.

A need remains to improve the aspects listed, allowing the pedal curve to be selected based on the driving mode, as well as to arrange the braking system for braking by reducing stroke skips.

### PURPOSE AND OBJECT OF THE INVENTION

It is the object of the present invention to provide an arrangement for a linear magnet for electronically assisted braking systems which overcomes the drawbacks and solves the problems of the prior art.

The present invention relates to a magnet housing device for electronically assisted braking systems according to the appended claims.

The present invention further relates to a foot brake which uses the magnet housing device of the invention, according to the appended claims.

### LIST OF DRAWINGS

The invention will now be described by way of a non-limiting example, with particular reference to the figures in the accompanying drawings, in which:

FIG. 1 shows as first solution of the prior art developed by the Applicant;

FIG. 2 shows a second solution of the prior art developed by the Applicant;

FIG. 3 shows a third solution of the prior art developed by the Applicant; and

FIG. 4 shows an embodiment of the magnet housing device according to the invention, in multiple views;

FIG. 5 shows an exploded view of a braking system using the magnet housing device according to the invention;

FIG. 6 shows the braking system in FIG. 5, not exploded; and

FIG. 7 shows the positioning of the magnet housing device according to the invention inside the float of the braking system in FIGS. 5 and 6, according to an embodiment of the invention.

### DETAILED DESCRIPTION OF EMBODIMENTS OF THE INVENTION

It is here specified that elements of different embodiments can be combined to provide further embodiments, without restrictions, by respecting the technical concept of the invention, as those skilled in the art will effortlessly understand from the description.

The present description also makes reference to the prior art for the implementation thereof in relation to the detail features not described, such as elements of minor importance usually used in the prior art in solutions of the same type, for example.

When an element is introduced, it is always understood that there can be “at least one” or “one or more”.

When a list of elements or features is given in this description, it is understood that the finding according to the invention “comprises” or alternatively “consists of” such elements.

When listing features in the same sentence or bullet list, one or more of the single features can be included in the invention without connection with the other features on the list.

### Embodiments

The solution described below solves the main problems related to the previous design making the system suitable for application on motorcycles, in particular.

### Magnet Housing Device

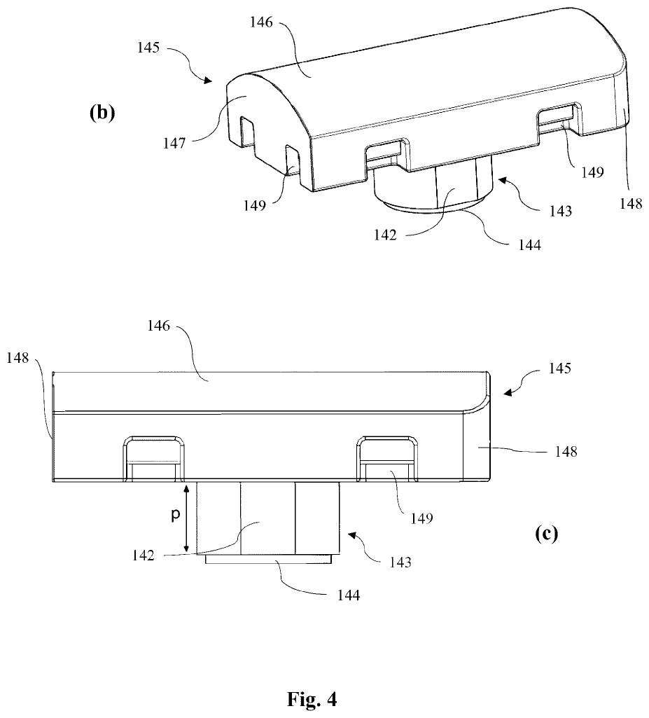

With reference to FIG. 4, the magnet housing device 140 has an elongated main body 145 in which a magnet (not shown) is positionable, with an upper surface 146 and a lower surface 141. A bushing 143 come out of the lower surface 141 in a projecting manner. In particular, the bushing 143 is positioned in a central region of the bottom surface 141.

In an embodiment, the housing 140 is molded from plastic in one piece, therefore both the main body 145 and the bushing 143 are molded from plastic.

The bushing 143 has a preferably cylindrical outer profile. However, the outer profile can have different shapes. Inside, however, there is a cylindrical threaded cavity 144a which is configured to engage the float of the braking system, as will be seen below.

According to a specific embodiment of the invention, the threaded cylindrical cavity is inside a ring 144 which protrudes in a projecting manner with respect to the outer profile of the bushing 143 so as to achieve a shape coupling in a corresponding shaped cavity of the float. The function of the protrusion 144 is to impose a single direction of magnet orientation.

Having an asymmetric geometry, the shape coupling allows a single orientation during assembly. Moreover, this prevents the relative rotation between float and magnet, when tightening the fixing screw.

The bushing 143, on the outer profile thereof, has a poka-yoke element, i.e., an element which ensures a correct and mistake-free assembly. For example, such a poka-yoke element can be a flat side 142 which breaks the cylindrical outer profile, as shown by way of example in the figure. Any other appropriate poka-yoke element is equally effective according to the invention.

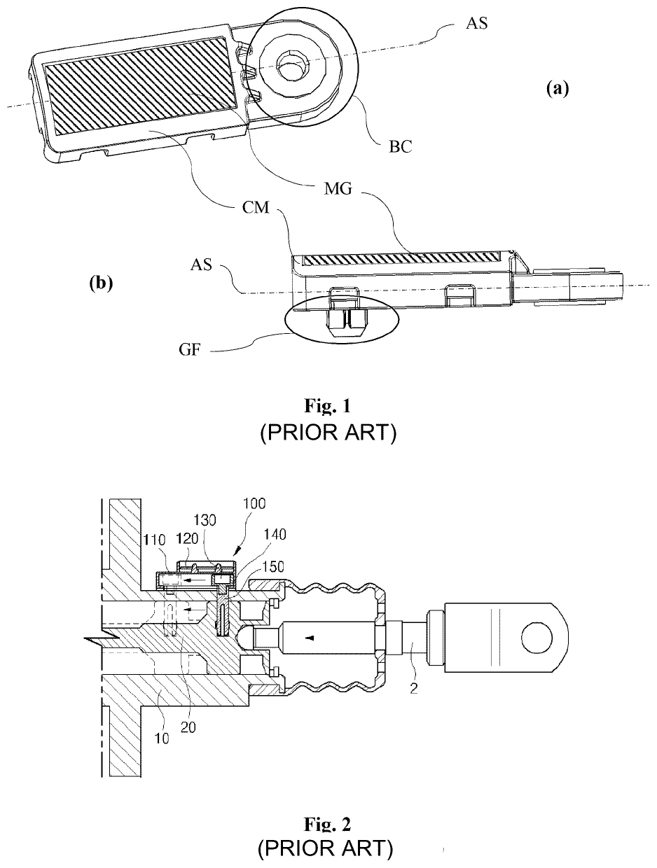

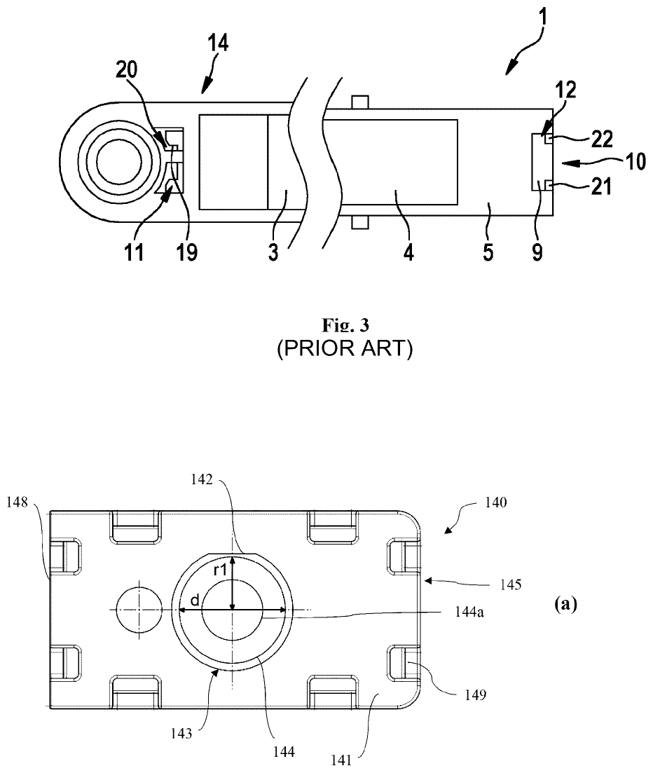

Note that the threaded bushing 143 is molded under the magnet housing, instead of along the axial extension of the magnet as in FIG. 1 and generally in the prior art, and this ensures that the longitudinal size is reduced.

Advantageously, the poka-yoke function can be configured to provide at the same time an anti-rotation function for the bushing (and thus for the magnet) when the bushing is screwed to a screw for being fixed to the float (see further down in this description). This function is necessary so as not to reverse the polarity of the magnet when mounted on the float.

By way of example, the upper 146 and lower 141 surfaces extend longitudinally between a first end side 145 and a second end side 148. Moreover, there can also be recesses or “reliefs” 149 on the side surface which joins the upper surface to the lower surface, provided to lighten the component and direct the cooling of the magnet housing.

In an embodiment of the invention, the upper surface 146 can be bulged.

In an embodiment of the invention, the lower surface 141 can be flat.

The device 140 according to the invention can be used in a braking system with a brake pedal, as described below, but it can also be used for any linear position sensor installed on a sliding element (e.g., a piston).

### Braking System

The present invention is adapted to be applied to a Brake-By-Wire (“BBW”) type braking system of vehicles with two or more wheels, which is actuatable by a driver by means of a brake pedal or lever. Therefore, hereafter, the term “brake pedal” means indistinctly both a brake pedal for motorcars and the like and a brake lever for motorcycles, mopeds, and the like, unless otherwise specified.

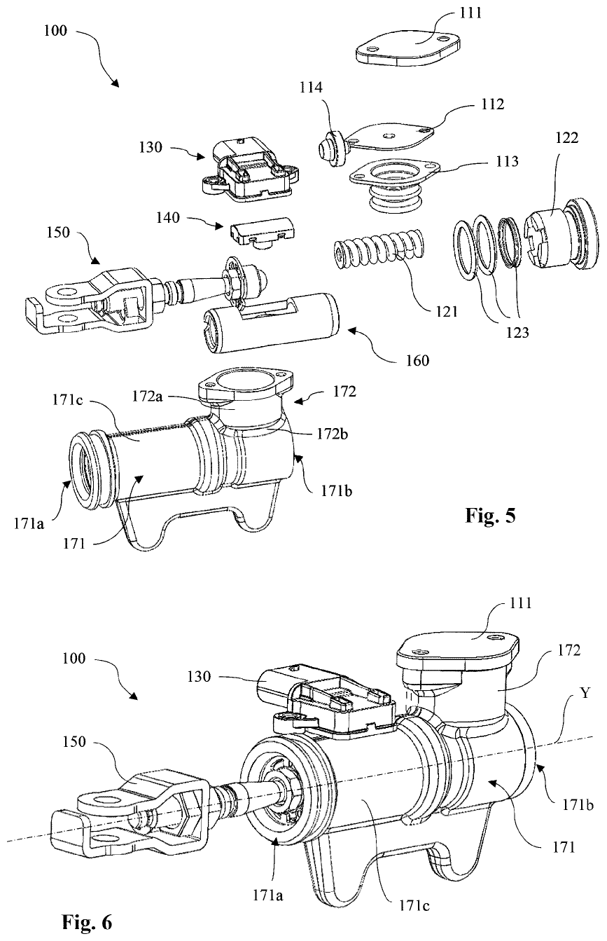

With reference to FIGS. 5 and 6, a braking system is generally indicated by reference numeral 100.

The braking system 100 comprises the following elements, which are better specified below:
brake lever 150;
absorber 171;
absorber cap 122;
absorber gaskets 123;
float with slot 160;
magnet housing device 140 with integrated magnet;
magnetic sensor 130;
elastic elements 121;
reservoir 172;
reservoir sealing elements 113;
spring guide 114,112; and
reservoir cap 111.

The braking system 100 comprises a reservoir 172 and an absorber 171. The reservoir 172 is configured to contain hydraulic fluid. The absorber 171 is configured to apply a reaction force to the brake pedal (not shown, connected to lever 150) against an actuation of the brake pedal. The absorber 171 is configured to contain hydraulic fluid.

According to an aspect of the invention, the reservoir 172 and the absorber 171 are directly fluidly connected to each other by means of a first hydraulic pipe (not shown). Such a first hydraulic pipe can comprise a calibrated orifice (not shown) interposed between the reservoir 172 and the absorber 171. Specifically, the calibrated orifice is configured to dampen a flow of hydraulic fluid passing between the absorber 171 and the reservoir 172. Advantageously, an actuation of the braking system 100 thus configured, in response to an actuation of the brake pedal, conveys a flow of hydraulic fluid from the absorber 171 to the reservoir 172, which is damped by the calibrated orifice. Such a damping, in combination with the contrasting action of the absorber 171, implements the reaction force in response to a brake pedal actuation which emulates the stiffness curve of a conventional braking system. Advantageously, a braking assembly thus configured is more compact than the devices of the prior art and is adapted to be installable inside the passenger compartment of a vehicle, in both the hanging brake pedal configuration and in the grounded brake pedal configuration.

Indeed, the braking system thus configured lacks a master cylinder interposed between the reservoir 172 and the absorber 171 and thus has smaller overall dimensions and size.

Specifically, the braking system 100 thus configured is without hydraulic machines interposed between the reservoir 172 and the absorber 171. With added advantage, a braking system 100 thus configured minimizes the idle stroke of the system itself. Indeed, since the braking system 100 has no master cylinder interposed between the reservoir 172 and the absorber 171, an actuation of the brake pedal corresponds to an immediate actuation of the absorber 171. With added advantage, a braking system 100 thus configured has lower tolerances in the generation of the stiffness curve, because the tolerances inherent in a master cylinder, which is absent indeed, are canceled. With added advantage, a braking system 100 thus configured is simplified compared to the prior art because it has no master cylinder. Such a simplification results in low costs and lower maintenance requirements. With added advantage, a braking system 100 thus configured has a greater safety, both real and perceived by the driver. Indeed, devices constantly subjected to high pressures, which would also require high dimensioning, are missing in the braking system 100 thus configured. Conversely, the braking system 100 thus configured is only subjected to a small transient pressure peak when the hydraulic fluid starts flowing from the absorber 171 to the reservoir 172.

The braking system 100 thus configured is configured to contain hydraulic fluid, with fluid continuity, inside the absorber 171 and the reservoir 172.

Therefore, in an operating configuration, the hydraulic fluid fills the absorber 171, the first hydraulic pipe, and at least partially the reservoir 172. Advantageously, the braking System 100 thus configured, with the absorber 171 in a hydraulic fluid bath, minimizes the idle stroke of the braking system itself.

According to an embodiment of the invention, the absorber 171 extends along an actuation axis Y, between a first absorber end 171a and an opposite second absorber end 171b.

According to an embodiment, the first hydraulic pipe extends along a direction substantially transverse to the actuation axis Y. Advantageously, such a configuration reduces the overall size of the braking system 100.

According to an embodiment, the absorber 171 is configured to be connectable to the brake pedal, preferably at the first absorber end 171a. Moreover, the absorber 171 is configured to be actuatable by the brake pedal at the first absorber end 171a.

According to an embodiment, the absorber 171 is configured so that an actuation of the brake pedal 3 corresponds to a pressurization of the hydraulic fluid contained in the absorber 171, which conveys a flow of hydraulic fluid from the absorber 171 to the reservoir 172, through the first hydraulic pipe.

According to an embodiment, the absorber 171 comprises a peripheral wall 171c substantially extending in a direction parallel to the actuation axis Y, between the first absorber end 171a and the second absorber end 171b. The peripheral wall 171 defines a housing compartment therein (not shown), configured to contain the hydraulic fluid.

According to an embodiment, the reservoir 172 comprises a containment wall 172a and a bottom wall 172b. The bottom wall 172b is substantially transverse to the containment wall 172a. The bottom wall 172b and the containment wall 172a form a reservoir compartment configured to contain the hydraulic fluid.

According to an embodiment, the containment wall 172a forms a top-up opening. Preferably, the top-up opening is positioned opposite to the bottom wall 172b. The top-up opening is configured to allow topping up hydraulic fluid in the reservoir 172. The top-up opening is closable by reservoir sealing elements 113 and a cap 112.

According to an embodiment, the first hydraulic pipe extends through the bottom wall 172b of the reservoir 172 and the peripheral wall 171c of the absorber 171. The first hydraulic pipe thus fluidly connects the reservoir compartment to the housing compartment (not shown). Advantageously, such a configuration reduces the overall size of the braking system.

According to an embodiment, the reservoir 171 is fixed to the absorber 172.

According to an embodiment, the reservoir 171 is made in one piece with the absorber 172.

According to an embodiment, the bottom wall 172b extends in a plane substantially parallel to the actuation axis Y and the containment wall 172a is substantially transverse to the actuation axis Y. According to an embodiment, the bottom wall 172b of the reservoir 172 substantially coincides with a portion of the peripheral wall 171c of the absorber 171.

According to an embodiment, the reservoir 172 is at least partially interpenetrated with the absorber 171.

According to an embodiment, the bottom wall 172b of the reservoir 172 is at least partially interpenetrated with the peripheral wall 171a of the absorber 171.

According to an alternative embodiment, the reservoir 172 is distinct from the absorber 171. The fluid connection between the reservoir 171 and a the absorber 172 is provided by the first hydraulic pipe.

Advantageously, the reservoir 172 thus configured is freely positionable and orientable with respect to the absorber 171.

According to an embodiment, the first hydraulic pipe comprises a flexible pipe (not shown), extending between the reservoir 172 and the absorber 171.

According to an embodiment, the absorber 171 comprises at least one elastic element 121 positioned inside the housing compartment (not shown). The at least one elastic element 121 is configured to apply a reaction force in response to an actuation of the braking system. Specifically, the at least one elastic element is configured to apply a reaction force to the brake pedal in response to an actuation of the brake pedal by a driver.

The at least one elastic element is configured to be biased along a direction substantially parallel to the actuation axis Y.

According to an embodiment, the absorber 171 comprises a plurality of elastic elements positioned in series and/or in parallel within the housing compartment.

According to an embodiment, the elastic elements 121 comprise a plurality of compression coil springs positioned substantially coaxial to the actuation axis Y.

According to an embodiment, the elastic elements comprise Belville washers and/or square springs and/or torsion springs and/or strip springs and/or shaped springs.

According to an embodiment, in an operating configuration, the at least one elastic element 121 is immersed in the hydraulic fluid. Preferably, the plurality of compression coil springs positioned substantially coaxial to the actuation axis Y is immersed in the hydraulic fluid.

According to an embodiment, the braking system comprises a second hydraulic pipe (not shown) which fluidly connects the reservoir 171 to the absorber 172.

The second hydraulic pipe is distinct from the first hydraulic pipe.

Advantageously, the second hydraulic pipe is configured to allow faster return of hydraulic fluid from the reservoir 172 to the absorber 171 following the release of the actuation of the braking system 100.

According to an embodiment, the second hydraulic pipe comprises a non-return valve interposed between the reservoir 172 and the absorber 171. The non-return valve is configured to allow a flow of hydraulic fluid from the reservoir 172 to the absorber 171, and prevent a flow of hydraulic fluid from the absorber 171 to the reservoir 172. Therefore, during the actuation of the braking system 100, the absorber 171 pushes the hydraulic fluid toward the reservoir 172, through the first hydraulic pipe and a calibrated gap, which implements a damping of the flow of hydraulic fluid. The non-return valve ensures that flow of hydraulic fluid from the absorber 171 to the reservoir 172 flows only through the first hydraulic pipe. Conversely, upon release of the braking system 100, the hydraulic fluid flows out to the absorber 171 more rapidly, because it flows out through both the first hydraulic pipe and the second hydraulic pipe.

According to an embodiment, the second hydraulic pipe extends parallel to the first hydraulic pipe. Advantageously, such a configuration reduces the overall size of the braking system.

According to an embodiment, the absorber 171 comprises a thrust shaft (not shown) therein (in the housing compartment). The thrust shaft is configured to be biased against the at least one elastic element in response to an actuation of the brake pedal.

According to an embodiment, the thrust shaft is configured to be translationally biased by the brake pedal along the actuation axis against the at least one elastic element. The absorber 171 thus applies a counteracting force against the actuation of the brake pedal.

According to an embodiment, the braking system comprises at least one sensor 130. The at least one sensor 130 is configured to detect an actuation and/or movement of the braking system 100, in cooperation with the magnet in the element 140, as will be discussed below.

According to an embodiment, the at least one sensor 130 is configured to detect the movement of at least one component of the braking system 100.

According to an embodiment, the at least one sensor 130 is configured to detect a movement of the thrust shaft within the absorber 171.

Preferably, the at least one sensor 130 is configured to detect a translation of the thrust shaft along the actuation axis Y. Advantageously, such a translation of the thrust shaft, actuatable by the brake pedal, can be correlated with the movement of the brake pedal by a driver. The movement of the brake pedal is usable to determine the braking force required by a driver from the braking system.

According to an embodiment, the at least one sensor 130 is either a Hall-effect position sensor or a magnetoresistive sensor or a linear magnetic sensor or a combination thereof, which utilizes the magnetic device 140 described above, for example.

According to an embodiment, the at least one sensor 130 (together with the device 140) is positioned inside the absorber 171. Preferably, the at least one sensor 130 is positioned inside the housing compartment.

According to an embodiment, the at least one sensor 130 is positioned connected to the thrust shaft.

According to an embodiment, the brake pedal is connected to the absorber 171 so that an actuation of the brake pedal corresponds to a pressurization of the hydraulic fluid contained in the absorber 171, which conveys a flow of hydraulic fluid from the absorber 171 towards the reservoir 172, through the first hydraulic pipe.

According to an embodiment, the brake pedal is connected to the absorber 171 by means of a mechanical connection, preferably by means of an articulated connection. An actuating force applied by a driver to the brake pedal is thus mechanically transferred to the absorber 171.

Advantageously, the connection between brake pedal and absorber 171 is without a hydraulic connection.

Specifically, the braking system 100 previously described is configured so that an actuation of the brake pedal by a driver corresponds to a reaction force applied by the braking system to the brake pedal against a brake pedal actuation, the force being implemented, for example, by the combined counteracting action of the absorber 171 and the calibrated orifice mentioned above, outside the system 100.

The absorber 171 is configured to generate a reaction force against an actuation of the brake pedal, e.g., by means of the at least one elastic element 121 configured to counteract the actuation of the brake pedal.

The calibrated orifice is configured to generate a damping force on the hydraulic fluid conveyed from the absorber 171 to the reservoir 172 through the first hydraulic pipe, under the actuation of the brake pedal, and such a damping force counteracts the actuation of the brake pedal.

The combined counteracting action of the absorber 171 and the calibrated orifice is configured to simulate the feel and stiffness of a brake pedal or lever of the conventional hydraulic braking systems. When the brake pedal is released, the hydraulic fluid previously conveyed from the absorber 171 to the reservoir 172 flows from the reservoir 172 to the absorber 171 passing through the first hydraulic pipe, and possibly also through the second hydraulic pipe.

According to an embodiment, the braking system 100 comprises at least one brake caliper. An electronic processing unit can be electrically connected to the braking system 100 and to the at least one brake caliper. The electronic processing unit is configured to actuate the at least one brake caliper upon detection, by the at least one sensor 130, of an actuation and/or movement of the braking system 100.

### Mounting the Magnetic Housing Device in the Braking System

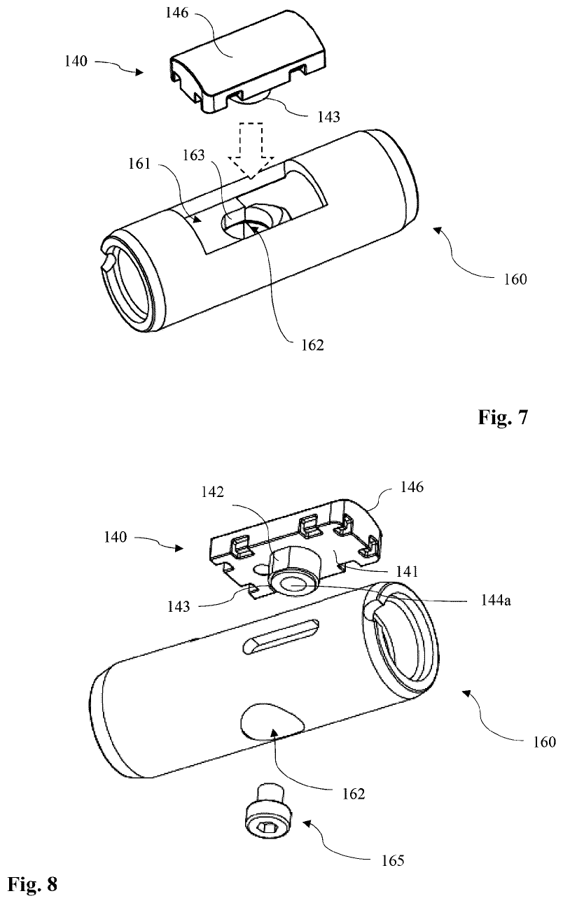

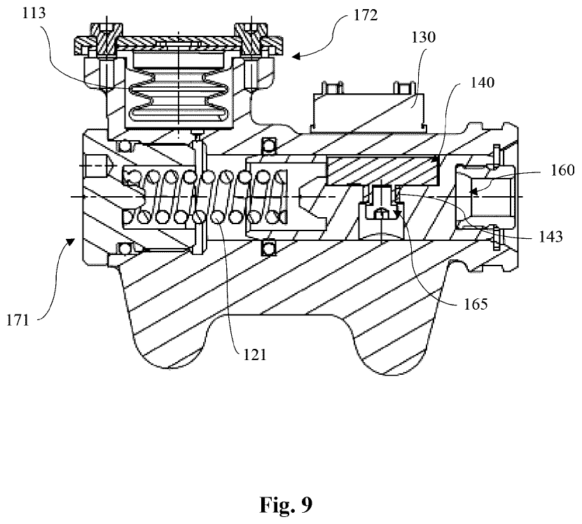

With reference to FIGS. 7 and 8, how the magnet housing device 140 is inserted into an appropriate housing of the float 160 is shown. In particular, the bushing 143 is inserted into a corresponding cavity 162 (of a shape corresponding to the bushing, which is not necessarily cylindrical), which can be in a central region of the float, inside the larger recess 161 receiving the device 140.

Reference numeral 163 indicates a portion of the inner surface of the cavity or recess 162, which corresponds to the poka-yoke element of the bushing 143. In particular, the portion 163 is a linear cut with respect to the circumference of the cylindrical cavity 162 (inside the recess 161) in the example shown.

In the cavity 162, which is a through cavity with respect to the float, a screw 165 can be inserted, which reaches the cylindrical opening 144a of the bushing 143 thus fixing the magnet housing 140 to the float 160.

According to an embodiment of the present invention, the threaded bushing 143 projects over a length p between 3 and 6 mm, even more preferably between 4 and 5 mm. This allows having a sufficient projecting portion for the poka-yoke anti-rotation mechanism, without risking bushing slippage or excessive stress.

According to a preferred embodiment of the present invention, the cylinder diameter d of said cylindrical bushing surface is between 6 and 10 mm. In this case, the distance r1 of the poka-yoke cut from the center of the cylinder is between 2.7 and 4.7.

More preferably, the cylinder diameter s of said cylindrical surface is between 7 and 9 mm, and in this case the distance r1 of the poka-yoke cut from the center of the cylinder is between 3.3 and 4.2. These values allow for and optimal poka-yoke operation because they provide a sufficient clamping surface for the stresses involved. The recess for the bushing and poka-yoke has corresponding dimensions.

FIG. 9 shows a section view of the bushing 143 fixed by means of the screw 165 to the float 160, which is mounted in the absorber 171.

Two or more of the parts (elements, devices, systems) described above can be freely associated and considered as a part kit according to the invention.

### Advantages of the Invention

The main advantages of the solution described above are:
reducing the axial dimension of the component;
ensuring a stronger fixing for the magnet (a safety-critical component); and
simplify the piston design by reducing cost and axial size.

In such a respect, it should be noted that the dimension of the electro-actuated pedal is the most critical feature, for example for the design of motorcycle applications because it needs to remain as close as possible to the actual pedal master cylinders.

Preferred embodiments have been described above and variations of the present invention have been suggested, but it should be understood that those skilled in the art may make modifications and changes without departing from the related scope of protection, as defined by the appended claims.

1-14. (canceled)

15. A magnet housing device for a linear position sensor installed on a sliding element in a longitudinal direction the magnet housing device comprising:
a magnet housing body with a first surface extending along said longitudinal direction and a second surface extending along said longitudinal direction opposite to the first surface; and
a threaded bushing projecting from said second surface in a direction perpendicular to said longitudinal direction;
wherein
the threaded bushing comprises an outer bushing surface with a poka-yoke element, and an inner cylindrical opening in a direction perpendicular to said longitudinal direction,
said inner cylindrical opening having an inner thread configured to receive a fixing screw.

16. The magnet housing device of claim 15, wherein the threaded bushing projects over a length between 3 and 6 mm.

17. The magnet housing device of claim 15, wherein the threaded bushing projects over a length between 4 and 5 mm.

18. The magnet housing device of claim 15, wherein said outer bushing surface is cylindrical surface.

19. The magnet housing device of claim 18, wherein a diameter of a cylinder of said cylindrical surface is between 6 and 10 mm.

20. The magnet housing device of claim 19, wherein a distance of a cut from a center of the cylinder is between 2.7 and 4.7 mm.

21. The magnet housing device of claim 19, wherein the diameter of the cylinder of said cylindrical surface is between 7 and 9 mm.

22. The magnet housing device of claim 19, wherein a distance of a cut from a center of the cylinder is between 3.3 and 4.2 mm.

23. The magnet housing device of claim 15, wherein said second surface is flat.

24. The magnet housing device of claim 15, wherein said magnet housing body and said threaded bushing are co-molded from plastic.

25. The magnet housing device of claim 15, wherein said threaded bushing is located in a central region of said second surface.

26. The magnet housing device of claim 15, wherein said threaded bushing comprises, within and with respect to an outer bushing circumference, a protrusion in a perpendicular direction, the protrusion containing said inner cylindrical opening.

27. A foot brake, comprising a brake pedal, a piston, a reservoir configured to contain a hydraulic fluid, an absorber comprising a float and configured to apply a reaction force to the brake pedal against an actuation of the brake pedal, a magnetic position sensor installed on said absorber, wherein the magnetic position sensor comprises a magnet housing device fixed, by shape coupling, to a float configured to pressurize the hydraulic fluid,
wherein:
the magnet housing device is a for a linear position sensor installed on a sliding element in a longitudinal direction, the magnet housing device comprising:
a magnet housing body with a first surface extending along said longitudinal direction and a second surface extending along said longitudinal direction opposite to the first surface; and
a threaded bushing projecting from said second surface in a direction perpendicular to said longitudinal direction;
wherein the threaded bushing comprises an outer bushing surface with a poka-yoke element, and an inner cylindrical opening in a direction perpendicular to said longitudinal direction, said inner cylindrical opening having an inner thread configured to receive a fixing screw;
said float comprises a recess configured to receive said magnet housing device, said recess including a cavity having a shape and dimensions corresponding to said threaded bushing; and
said shape coupling is configured so that said poka-yoke element does not allow a rotation of said threaded bushing with respect to the float and uniquely identifies mutual position between float and the magnet housing device.

28. The foot brake of claim 27, wherein the magnet housing device comprises an inner cylindrical opening in the threaded bushing and is fixed to said float by the fixing screw screwed into said inner cylindrical opening.
